(19) United States
(12) Patent Application Publication
(10) Pub. No.: US 2004/0181638 A1
(43) Pub. Date: Sep. 16, 2004

(54) Event queue system

(76) Inventors: Paul Linehan, Belfast (GB); Shane O'Neill, Belfast (GB); John Donaghy, Belfast (GB); Armin Lackermeier, Ballymena (GB); James McKee, Belfast (GB)

Correspondence Address: William M. Lee, Jr., Barnes & Thornburg, P.O. Box 2786, Chicago, IL, 60690-2786, US

(21) Appl. No.: 10/389,207

(22) Filed: Mar. 14, 2003

(51) Int. Cl. G06F 12/00

(52) U.S. Cl. 711/156; 711/118

(57) ABSTRACT

A system comprises a main processor, one or more sub-processors and an event queue apparatus arranged to queue events to be transmitted between the main processor and the sub-processors. The event queue apparatus comprises one or more storage devices arranged to implement a plurality of event queues; and an event queue status indicator, including a respective status component for each event queue. The status components indicate if the respective event queue contains at least one event. The main processor associates a respective priority with each status component and selects to handle an event from the event queue associated with the highest priority of the non-empty event queue(s).

### FIELD OF THE INVENTION

The present invention relates to event queuing. In particular, the invention relates to an event queue apparatus, especially for use in a multi-processor system, and to a method of managing a plurality of event queues.

### BACKGROUND TO THE INVENTION

In a multi-processor system, a plurality of data processors perform one or more respective tasks. Commonly, a multi-processor system includes a main data processor and a plurality of sub-processors, wherein the sub-processors perform their respective task(s) and report to the main processor when one or more predetermined events occur. The main processor then processes each valid event reported to it by the sub-processors. The main processor typically comprises a microprocessor, or central processing unit (CPU), while the sub-processors may comprise a hardware processor or a software processor (e.g. a computer program).

In many systems, the sub-processors operate simultaneously in real-time and therefore, in a given time interval, a plurality of events may be signalled to the main processor. Accordingly, it is usual to implement an event queuing system to manage the signalled events.

It is known to implement an event queuing system using memory blocks shared amongst the sub-processors and implementing direct memory access (DMA) controllers to provide bus arbitration. However, this is considered to be relatively complex. It is also considered that such event queue systems do not operate quickly enough to cope with many modern applications, particularly real-time telecommunications applications. For example, pointer processing systems in SDH (Synchronous Digital Hierarchy)/SONET (Synchronous Optical Network) equipment may have to process over 600 events in each 500 μs multi-frame.

Further, event handling between hardware and software is conventionally performed using interrupts and Interrupt Service Routines (ISRs). ISRs are considered to be inefficient as a result of the processing time required by an ISR to save the internal process registers. Where there are multiple interrupt sources and a limited number of interrupt lines, it is necessary for an ISR to perform multiple read operations from an interrupt controller to determine the interrupt source. It is considered that conventional ISR techniques are cumbersome and add to the difficulty of coping with event queuing and handling in applications where processing time is of paramount importance.

It would be desirable, therefore, to provide a more efficient system for the queuing and handling of events in multi-processor systems.

### SUMMARY OF THE INVENTION

Accordingly, a first aspect of the invention provides an event queue apparatus comprising: one or more storage devices arranged to implement a plurality of event queues; and an event queue status indicator, including a respective status component for each event queue, wherein the apparatus is arranged to cause the status components to indicate if the respective event queue contains at least one event.

Preferably, each event queue is implemented by a respective first-in first-out (FIFO) memory.

Preferably, event queue status indicator comprises a data register, each status component comprising one or more respective bits of the data register.

Preferably, each FIFO memory is associated with a respective fill level monitor arranged to monitor the number of events in the respective event queue and to cause the respective status component to indicate when the respective event queue is not empty.

In the preferred embodiment, the apparatus is arranged for queuing events to be transmitted between a first processor and one or more second processors, wherein each FIFO memory includes a plurality of event data storage locations and is arranged to receive event data from one or more of said second processors, which event data is stored in a respective event data storage location, each FIFO memory being further arranged to supply the least recently received event data to said main processor.

More preferably, each FIFO memory is associated with a respective read/write pointer generator arranged to generate a write pointer for identifying into which event data location event data is written, and a read pointer for identifying from which event data location event data is supplied to the first processor, wherein, after event data is written to one event data storage location, the read/write pointer generator adjusts the write pointer to identify the next available event storage location, and wherein, in response to receipt of a read request from said main processor, the read/write pointer generator adjusts the read pointer to identify the event data storage location holding the least recently received event data.

Preferably, the fill level monitor is arranged to compare the respective values of the write pointer and the read pointer in order to determine if at least one event data storage location of the respective FIFO memory contains event data. More preferably, the fill level monitor is arranged to determine that at least one event data storage location holds event data if the value of the read pointer does not match the value of the write pointer.

A second aspect of the invention provides a system comprising a first processor, one or more second processors and an event queue apparatus arranged to queue events to be transmitted between said first processor said one or more second processors, the event queue apparatus comprising: one or more storage devices arranged to implement a plurality of event queues; and an event queue status indicator, including a respective status component for each event queue, wherein the apparatus is arranged to cause the status components to indicate if the respective event queue contains at least one event.

Preferably, said first processor is arranged to associate a respective priority with each status component and is further arranged to select to handle an event from the event queue associated with the highest priority of the or each event queue in respect of which the respective status component identifies as containing at least one event. More preferably, said first processor associates a respective priority with each status component depending on the position of the status component in the event queue status indicator.

A third aspect of the invention provides a method of managing a plurality of event queues in a system according to the second aspect of the invention, the method comprising: associating a respective priority with each status component; and selecting to handle an event from the event queue associated with the highest priority of the or each event queue in respect of which the respective status component identifies as containing at least one event.

A fourth aspect of the invention provides a computer program product comprising computer useable instructions for causing a computer to perform the method of the third aspect of the invention.

A fifth aspect of the invention provides a network element for a synchronous transport system, the network element comprising a system of the second aspect of the invention.

Other advantageous aspects and features of the invention will be apparent to those ordinarily skilled in the art upon review of the following description of a specific embodiment of the invention and with reference to the accompanying drawings.

The preferred features as described herein above or as described by the dependent claims filed herewith may be combined as appropriate, and may be combined with any of the aspects of the invention as described herein above or by the independent claims filed herewith, as would be apparent to those skilled in the art.

### BRIEF DESCRIPTION OF THE DRAWINGS

Specific embodiments of the invention are now described by way of example and with reference to the accompanying drawings in which:

FIG. 1 is a block diagram of a multi-processor system including an embodiment of an event queue system according to one aspect of the invention;

FIG. 2 is a block diagram a multi-processor system including an embodiment of an event queue system according to one aspect of the invention, wherein the multi-processor system comprises an SDH/SONET pointer processing system; and

FIG. 3 illustrates a first-in first-out data memory with associated control circuitry.

### DETAILED DESCRIPTION OF THE DRAWINGS

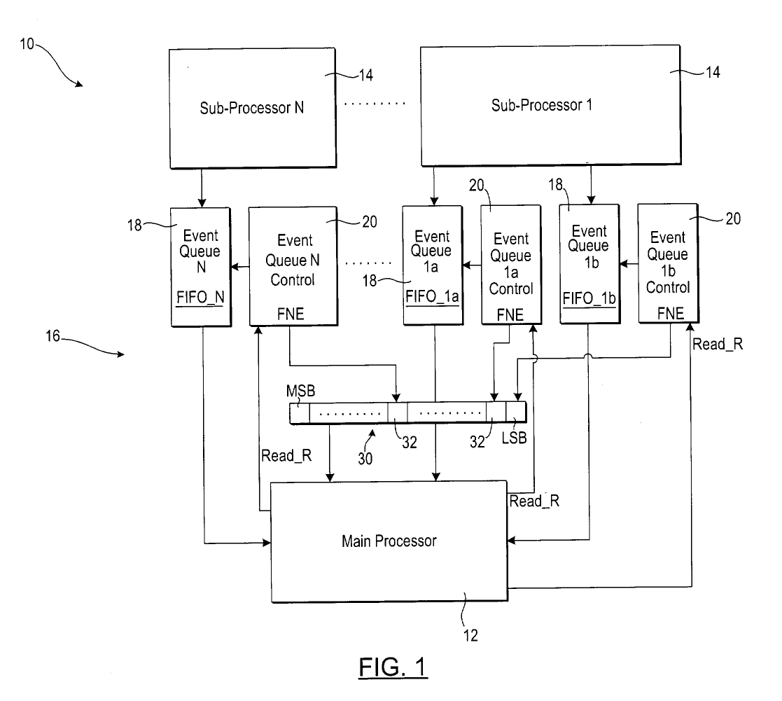

Referring now to FIG. 1 of the drawings, there is shown, generally indicated as 10, a multi-processor system comprising a first, or main, data processor 12 and a plurality of second processors, or sub-processors 14. The main processor 12 typically comprises a microcontroller, microprocessor or CPU (central processing unit) arranged to run one or more computer programs, for example applications software and/or systems software. Each sub-processor 14 may comprise a hardware processor, for example an integrated circuit or other logic circuit, or a software processor, for example a computer program, or may itself comprise a microcontroller, CPU or other data processor. Hence, the multi-processor system 10 may take a wide variety of forms ranging from, for example, a computer system wherein the main processor 12 comprises a CPU running an operating system and the sub-processors 14 each comprise system or application software to be run under the control of the operating system, to a System-on Chip architecture where the main processor 12 comprises a microcontroller or CPU and the sub-processors 14 comprise hardware processors, all being included in a single Integrated Circuit (IC).

Each sub-processor 14 is arranged to perform one or more tasks and to report one or more different events to the main processor 12. Events may take a wide variety of forms ranging from, for example, notification that a particular task has been completed, or, where the sub-processor 14 is monitoring, say, a signal or activity, the event may be a particular occurrence associated with that signal or activity. Commonly, an event involves passing state information at a given sampling point to a software controlled state machine implemented on the main processor 12. When signalling an event, a sub-processor 14 typically provides data identifying the event and, where appropriate, also provides one or more parameters or other data associated with the event.

The main processor 12 is arranged to perform one or more respective event handling routines in respect of each event using, where applicable, the parameters or other data supplied with the event notification. Where the main processor 12 comprises a CPU, microcontroller or the like, an event handling routine typically comprises one or more computer programs supported by the main processor 12. Hence, when an event is signalled to the main processor 12, a respective event handling routine detects, or is informed of, the event and causes the event to be handled in an appropriate manner.

In FIG. 1, it is assumed that the system 10 includes N sub-processors 14 (although only two are shown), where N may be any number greater than 1. Each sub-processor 14 may be arranged to signal one or more instances of one or more types of events to the main processor 12. The sub-processors 14 may also operate in parallel with the result that, in any given time interval, multiple events may be signalled to the main processor 12. Therefore, it is necessary to implement a queuing system for the events.

Accordingly, the multi-processor system 10 is arranged to implement an event queue system embodying one aspect of the invention. To this end, the multi-processor system 10 includes event queue apparatus, generally indicated as 16, comprising a plurality of first-in first-out (FIFO) data storage devices, or memories 18. In a FIFO data memory 18 (commonly referred to as a FIFO), data is effectively queued so that data blocks are read from the memory 18 in the same order in which they were stored in the memory 18—hence, first-in, first-out. Each data memory 18 includes a plurality of memory locations (not shown in FIG. 1), each memory location being large enough to store event data generated by the sub-processors 14. A FIFO may be implemented using a conventional storage device, for example RAM (Random Access Memory). Moreover, one storage device may be arranged to implement one or more FIFOs, or a separate respective storage device may be used to implement each FIFO. It will be seen that the main function of the event queue apparatus 16 is to transmit data from the sub-processors 14 to the main processor 12.

Each sub-processor 14, in signalling an event, is arranged to cause the respective event data (typically identification of the event (event_ID) together with any associated parameters or data) to be stored in a FIFO 18. Each sub-processor 14 may be arranged to store event data in one or more FIFOs 18, and each FIFO 18 may be arranged to receive event data from one or more sub-processors 14. In FIG. 1, by way of illustration only, it is assumed that sub-processor N is arranged to store event data only in FIFO_N, while sub-processor 1 may store event data in either FIFO_{—}1 a or FIFO_{—}1 b.

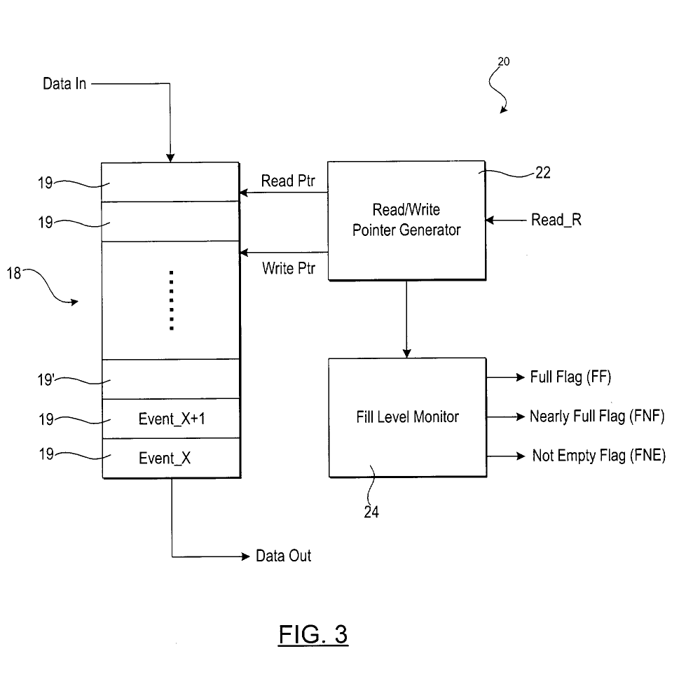

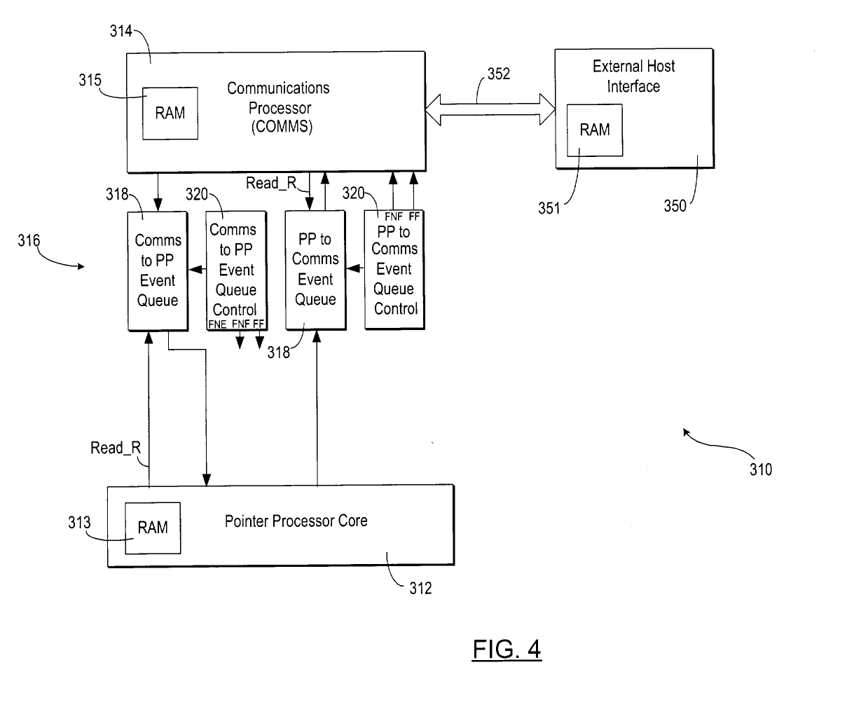

Each FIFO 18 is associated with respective control circuitry, shown in FIG. 1 as respective control blocks 20. The control circuitry for a FIFO 18 may take many forms. FIG. 3 illustrates a FIFO 18 with simplified control circuitry suitable for use as a control block 20. In FIG. 3, a FIFO 18 is shown having a plurality of memory locations 19 for storing event data. It will be understood that each memory location may comprise one or more physical memory locations depending on the storage space required to store the event data. The memory locations 19 may therefore be referred to as event data storage locations.

Event data is written to the FIFO 18 on input Data In and read from FIFO 18 on output Data Out. When event data is received on Data In, it is stored in the next available memory location 19 in queue order. For example, in FIG. 3 it is assumed that event data in respect of Event_X and Event_X+1 are stored in successive memory locations 19 as shown pictorially in FIG. 3. When the next event, Event_X+2, is received, its data is stored in the next available memory location 19′, the arrangement being such that, when reading event data from the FIFO 18, Event_X data is read in response to a first read request, followed by Event_X+1 data at the next read request, and then Event_X+2 data at the next read request.

To control the writing and reading of data to and from the FIFO 18, the control circuitry includes a Read/Write pointer generator 22. The Read/Write pointer generator 22, generates and updates a read pointer (Read Ptr) and a write pointer (Write Ptr) the respective values of which determine, respectively, to which memory location 19 the next event data is written, and from which memory location 19 the next event data is read. When event data is written to a memory location 19, the Read/Write pointer generator 22 updates (typically increments) the write pointer.

The control circuitry is arranged to receive a read request from the main processor 12. This is shown in FIG. 3 as signal Read_R received by the Read/Write pointer generator 22. In response to a read request from the main processor 12, the Read/Write pointer generator 22 updates (typically increments) the read pointer and the next available, or least recently received, event data is supplied to the main processor 12 via Data Out.

The control circuitry also includes a fill level monitor 24 arranged to provide data relating to the fill level of the FIFO 18. The fill level monitor 24 is arranged to receive from the Read/Write pointer generator 22 an indication of the current values of the read pointer and the write pointer. The fill level monitor 24 compares the current values of the read pointer and the write pointer and sets one or more flags accordingly. In the illustrated example, the fill level monitor 24 provides three signals or flags, namely a FIFO Full (FF) flag, a FIFO Nearly Full (FNF) flag and a FIFO Not Empty (FNE) flag. The FF flag is set when all available memory locations 19 contain valid event data and may be used to indicate to the main processor 12 that the next write operation will destroy valid event data. The FNF flag is set when the number of spare memory locations 19 in the FIFO 18 equals the value written to a threshold register (not shown) by the main processor 12. The threshold value is a measure of the number of spare memory locations 19 in the FIFO 18, not an indication of the number of valid event data in the FIFO 18. The FNE flag is set whenever there is one or more valid event data in the FIFO 18, i.e. when at least one memory location 19 holds valid event data. The fill level monitor 24 may conveniently determine that the FIFO 18 is not empty when the compared read and write pointer values do not match. When the last valid event data is read from the FIFO 18, the FNE flag is cleared. For the purposes of the invention, only the FNE flag is used. It will be understood that the term ‘set’ as used herein may, when used in relation to binary components, mean either set to ‘1’ or set to ‘0’.

Hence, each FIFO 18 implements a respective event queue which may be empty, i.e. contain no valid event data, or contain event data in respect of one or more events generated by one or more of the sub-processors 14. Within each event queue, event data is queued in the order in which it was provided to the respective FIFO 18.

Some events may be deemed to be more important than others and so the event queue apparatus 16 is arranged to implement a priority system so that more important events may handled by the main processor 12 before less important events. To this end, each FIFO 18 is associated with a respective priority level or designation which indicates the relative importance of the event data stored in the respective FIFO 18. Each sub-processor 14 is arranged to cause its event data to be stored in a FIFO 18 whose priority designation best represents the relative importance of the respective event. A sub-processor 14 that generates more than one type of event may be arranged to store different event types in different FIFOs 18 according to the respective importance of the event types. Moreover, two or more different sub-processors 14 may generate different event types each of which is deemed to be equally important and are therefore stored in the same FIFO 18, or event queue. It will be seen from the description below that, in the preferred embodiment, it is the main processor 12 which determines the respective priorities associated with the event queues.

In FIG. 1, it is assumed for illustration purposes that event data stored in Event Queue 1a (i.e. in FIFO_{—}1 a) is more important than event data stored in Event Queue_{—}1 b (i.e. in FIFO_{—}1 b) but of lower importance than event data stored in Event Queue_N (i.e. in FIFO_N). Hence, the priority designation assigned to Event Queue_{—}1 b is lower than the priority designation assigned to Event Queue_{—}1 a which, in turn, is lower than the priority designation assigned to Event Queue_N.

The event queue apparatus 16 further includes an event queue status indicator, conveniently in the form of a status register 30. The status register 30 includes a respective component 32, conveniently a data bit, for each FIFO 18, i.e. for each event queue. The setting of the respective register component 32 indicates whether or not the respective event queue contains at least one valid event. In the present embodiment, the setting respective register component 32 indicates whether or not at least one memory location 19 in the respective FIFO 18 contains valid event data.

Setting the respective register components 32 can be achieved using the respective FNE flag generated by the respective control block 20 of each FIFO 18. This is illustrated in FIG. 1 in which the respective FNE flag generated by the respective control block 20 of each FIFO 18 is used to control the setting of the respective register component 32. It is assumed, for illustration purposes, that each register component 32 comprises a single bit in the register 30, the respective bit being set to ‘1’ if the respective FNE flag indicates that corresponding event queue is not empty, and to ‘0’ if the respective FNE flag indicates that the corresponding event queue is empty. By way of example, the status register 30 may be implemented by a memory location or register within the main processor 12, or accessible by the main processor 12. The FNE flags may be arranged to set the contents of the status register 30 in any convenient conventional manner.

Since there is a one-to-one correspondence between register components 32 and event queues, each register component 32 is associated with a respective priority designation corresponding to the respective priority of the associated event queue.

The main processor 12 uses the status register 30 to determine which of the event queues next requires its attention. When the main processor 12 is idle, it checks the status of the event queues by examining the settings of the register components 32. The main processor 12 selects to process an event from the event queue which is associated with the highest priority designation of the event queue(s) in respect of which the respective register component 32 indicates that there is at least one event to be processed (i.e. the main processor 12 selects to handle an event from the event queue with the highest priority of the non-empty event queue(s)).

Conveniently, the main processor 12 can determine the relative priority designation of a register component 32 by its position within the register 30. For example, in the preferred embodiment, the most significant bit (MSB) of the register 30 is deemed to represent the event queue of highest priority, while the least significant bit (LSB) is deemed to represent the event queue of lowest priority, the intermediate bits from MSB to LSB being associated with respective event queues of progressively lower priority. This arrangement allows the main processor 12 to identify the highest priority event queue which is not empty by comparing the value of the status register's 30 contents with appropriate threshold values. For example, assuming that only three event queues need to be implemented and that only three FIFOs A, B and C (not shown) are included in the event queue apparatus 16, then the status register 30 comprises only three respective register components 32. It is assumed also that FIFO_A holds the event queue with highest priority and is represented by the MSB, while FIFO_C holds the event queue with lowest priority and is represented by the LSB. Depending on whether or not each FIFO 18 is empty of valid event data, the register's 30 contents will range from binary 000 (all queues empty) to 111 (all queues not empty). The main processor 12 may determine which event queue to process next by implementing algorithm [1] below (in which numbers are given in binary):

Example algorithm [1]:

Read status register;

If register contents>011, then read next event data from FIFO_A;

If 001<register contents<=011, then read next event data from FIFO_B;

If register contents=001, then read next event data from FIFO_C;

Else all event queues empty.

A skilled person will appreciate that there are many alternative ways in which the main processor 12 could examine and evaluate the contents of the status register 30. The method described above is advantageous as it only requires that the register 30 be read once.

Once the main processor 12 has determined from the status register 30 which event queue should next be attended to, it sends a read request to the FIFO 18 which stores the event data of the identified event queue. The next-in-line, or least recently received, event data is then sent from the respective FIFO 18 to the main processor 12, upon receipt of which the main processor 12 performs whatever event handling routine(s) are appropriate to the event in respect of which the data is read.

In this way, the main processor 12 continues to process higher priority events until the respective event queue is empty at which time the main processor 12 moves on to a lower priority event queue.

Advantageously, the respective priority designation assigned to each register component 32 may be adjusted by the main processor 12. Thus, if for any reason, it is deemed that the relative importance of the events should change, then the main processor 12 may readily be re-programmed to re-prioritise the respective event queues by assigning alternative priorities to the respective register components 32. In the example algorithm [1], this is readily implemented by swapping the FIFO read statements appropriately.

The event queue apparatus 16 described above is considered to be more efficient than using interrupts generated by the FNE flags. Interrupt Service Routines (ISRs) are less efficient because the ISR needs to save some internal process registers, then (depending on the complexity of the interrupt controller) has to perform one or more read operations on the interrupt controller registers to determine the interrupt source, as well as performing other interrupt controller housekeeping such as disabling, clearing, and enabling interrupts. In contrast, using a status register 30 as described above, only a single register read operation is required to identify the event source(s) and the main processor 12 is able to read event data without any further handshaking. Moreover, the event queue apparatus 16 obviates the need for bus arbiters particularly in cases where there are multiple hardware sub-processors 14 serviced by the main processor 12. A further benefit is the reduction in memory requirements.

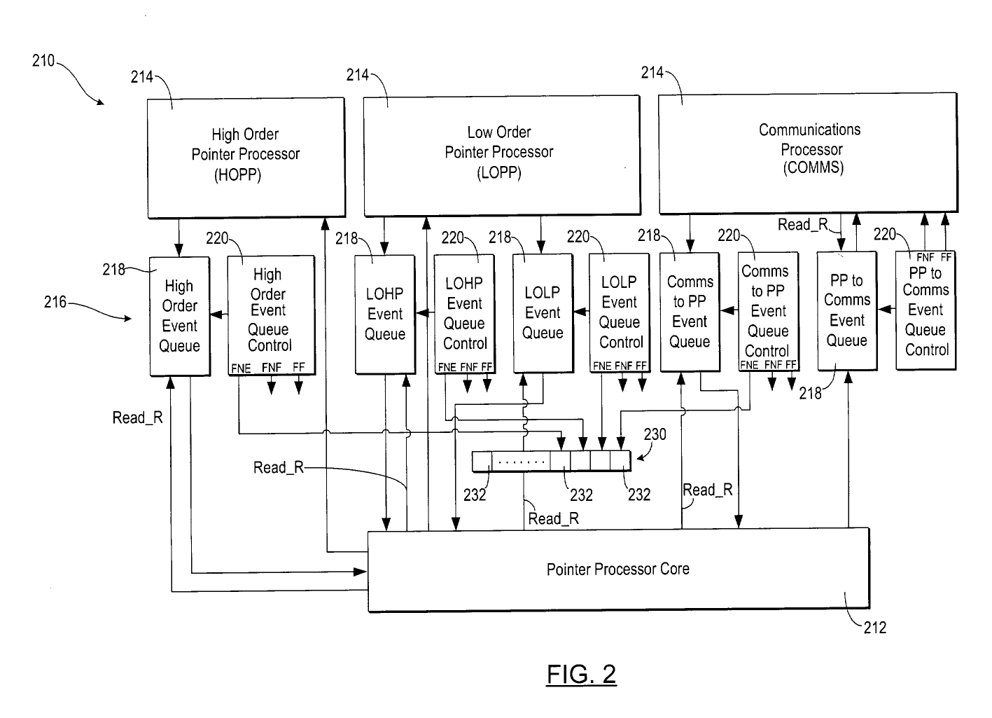

FIG. 2 illustrates a specific embodiment in which there is a multi-processor system in the form of an SDH/SONET pointer processing apparatus 210 including an event queue apparatus 216. The multi-processor system 210 and event queue apparatus 216 of FIG. 2 are generally similar to the system 10 and event queue apparatus 16 of FIG. 1 and, accordingly, like numerals are used to indicate like parts.

The pointer processing apparatus 210 is arranged to perform pointer processing in accordance with industry standards for SDH/SONET systems, particularly ITU_T standard G.707, and includes three sub-processors 214 in the form of a High Order Pointer Processor (HOPP), a Low Order Pointer Processor (LOPP) and a communications processor (COMMS), and a main processor 212 in the form of a pointer processor core. Each of the sub-processors 214 are normally implemented as hardware processors in view of the speed at which they are required to operate. Their functions are outlined below with reference to, and using the terminology of the relevant industry standards.

The High Order Pointer Processor hardware block (HOPP) performs the hardware portions of a combined hardware/software pointer processing function, namely it locates the position of floating VC-4s and HO VC-3s (as described in G.707 March 1996 (Draft 2000) Section 8.1, AU-n pointer, and G.783 April 1997, Annex B, Pointer Interpretation State Machine) and floating STS1 SPEs (as described in Belcore GR253 Issue 2 Revision 2—January 1999, Section 3.5.1, STS Payload Pointer; it terminates VC-4/HO VC-3/STS-1 SPE's containing LO Structures as described in G.707 Section 8.1 and GR253 Section 3.5.1); it performs pointer processing of STS-1's in Bypass mode, as described in GR253 Section 3.5.1, to support path overhead monitoring; and the first byte of the SDH/SONET frame, the section overhead, the HO pointer bytes, the path overheads and the payload are labelled. The SDH overhead bytes are described in G.707 Section 9, the SONET overhead bytes are described in GR253 Section 3.3.2.

Normal inputs (not shown) to the HOPP which may give rise to events are as follows: SDH/SONET Data input record; configuration information from the processor; multi Frame Synchronise signal; Frame Synchronise signal. Normal outputs from the HOPP are: SDH/SONET Data input record; and events to the main processor 212 via the High Order Event Queue 218.

The Low Order Pointer Processor hardware block (LOPP) performs the hardware portions of a combined hardware/software pointer processing function, namely it locates the position of the payload region of each floating low order structure, as described in G.707 Sections 8.2 TU-3 Pointer and 8.3 TU-2/TU-1 Pointer, G.783 Annex B, Pointer Interpretation State Machine, and in GR273 Section 3.5.2 VT Payload Pointer; it terminates the STS-1 SPE/VC-4/High order VC-3H4 byte count; and it marks the low order payload path overhead bytes.

Normal inputs (not shown) to the LOPP which may generate events are: SDH/SONET Data input record; and configuration information from the main processor 212.

Normal outputs from the LOPP are: SDH/SONET Data input record; high priority events to the pointer processor 212 via a Low Order High Priority (LOHP) Event Queue 218, e.g. a pointer event for VC-3 payloads where the pointer must be processed before the start of the next frame (1 frame every 125 microseconds) and low priority events to the pointer processor core via a Low Order Low Priority (LOLP) Event Queue 218, e.g. a pointer event for other low order payloads where the pointer must be processed within 4 frames (multiframe).

The communications processor (COMMS) is generally similar to the main processor 212. The main purpose of the communications processor (COMMS) is to serve as a bridge or interface between the equipment (not shown) of which the pointer processing apparatus 210, in use, forms part and external equipment (not shown). As can be seen from FIG. 2 the event queue apparatus 216 includes two event queues (FIFOs) 218 between the main processor 212 and the COMMS processor 214, one being arranged to queue events passing from the COMMS processor 214 to the main processor 212, the other being arranged to queue events passing from the main processor 212 to the COMMS processor 214.

Hence, the event queue apparatus 216 includes 5 event queues, each implemented by a respective FIFO 218. The High Order (HO) Event Queue, Low Order High Priority (LOHP) Event Queue, Low Order Low Priority (LOLP) Event Queue and COMMS to PP Event Queue are each associated with a respective bit 232 in status register 230. In this embodiment, the relative priority of events stored in these event queues, from highest priority to lowest priority, is: HO, LOHP, LOLP, COMMS to PP. The respective bits 232 in status register 230 are arranged with a respective relative significance in the register 230 corresponding to the respective relative priority of the respective event queue. Hence, the main processor 12 selects to process an event from an event queue corresponding to the most significant bit 232 which indicates that its respective queue is not empty.

In an SDH/SONET network (not shown), the pointer processing apparatus 210 is normally a sub-system in network equipment, or network elements, which transmit, receive, switch and perform other processing on SDH/SONET traffic signals. Typically, network elements comprise multiplexers, regenerators or cross-connects. A skilled person will understand that the event queuing system and apparatus described herein may equally be employed in other sub-systems of SDH/SONET network elements. For example, event queuing apparatus 16, 216 of the type described and illustrated herein may be used between the hardware path overhead monitor and associated processors, or the pointer generation hardware and associated processors.

The invention is not limited to the embodiments described herein which may be modified or varied without departing from the scope of the invention.

A further, advantageous aspect of the invention is now described with reference to FIG. 4. In a multi-processor system, each processor needs to be initiated, or booted, with appropriate computer program code. Conventionally, each processor has direct external access, i.e. is arranged for direct communication with one or more processors or other systems which are external to the multi-processor system (hereinafter referred to as external hosts). Hence, each processor in the multi-processor system may be booted directly from an external host, typically via an external communications bus. However, in some systems, particularly system-on-chip architectures, not all processors necessarily have access to an external host. It is therefore necessary to device an alternative means for booting such processors.

FIG. 4 shows part of a multi-processor system 310 which is generally similar to the system 210 shown in FIG. 2 and in which like numerals are used to indicate like parts. The COMMS processor 314 is arranged to communicate with an external host interface 350. Typically, the communication takes place via an external communications bus 352 arranged to support a suitable protocol, for example the Advanced High-performance Bus (AHB) protocol.

The pointer processor 312 does not have direct access to the external host interface 350. The pointer processor 312 communicates with the COMMS processor 314 via the event queue apparatus 316 as described above. The communications link between the pointer processor 312 and the COMMS processor 314 may be said to comprise a communication bridge. For example, the event queue apparatus 316 may be arranged to implement an Inter AHB Bridge between the COMMS processor 314 and the pointer processor 312, in which case the respective communications links between the event queue apparatus 316 and the COMMS processor 314 and between the event queue apparatus 316 and the pointer processor 312 may be said to comprise an AHB communications link.

The external host interface 350, the COMMS processor 314 and the pointer processor 312 each has, or has access to, a memory (for example Random Access Memory (RAM) or Dynamic RAM (DRAM)) for computer program code. In FIG. 4, the external host interface 350, the COMMS processor 314 and the pointer processor 312 are each associated with a respective RAM 351, 315, 313, in which computer program code may be stored and from which computer program code may be downloaded and/or executed. RAMs 315, 313 may be referred to as instruction RAMs (I-RAMs).

In accordance with this aspect of the invention, at least one of the FIFOs 318 is configurable between an event queue mode, in which the FIFO 318 implements an event queue as described above, and a boot mode, in which the FIFO 318 is arranged to serve as normal RAM, or equivalent memory, by which computer program code may be provided to one or more processors which do not have access to an external host. In the preferred embodiment, the communications bridge, as provided by the event queue apparatus 316, comprises two FIFOs 318 that are arranged to provide external address and data access to the respective memory locations (not shown in FIG. 4) of the FIFOs when in boot mode. The FIFOs 318 may thus be accessed as RAM when in boot mode. In boot mode, the FIFO control blocks 320 may be disabled.

It will be seen that, in event queue mode, the communications bridge between the COMMS processor 314 and the pointer processor 312 is arranged to serve as the event queue apparatus 316 described above, while in boot mode, the communications bridge is arranged to serve as a boot mechanism by providing RAM to allow communication of computer program code between processors 314, 312. The FIFOs 318 are configurable for use in either mode. This re-use of hardware resources improves the efficiency of the multi-processor system.

In the example of FIG. 4, computer program code (not illustrated) may be downloaded from RAM 351 of the external host interface 350 via communications link 352 and stored in RAM 315 of the COMMS processor 314. Subsequently, the downloaded computer program code may be provided to RAM 313 of the pointer processor 312 via one or more of FIFOs 318 when in the boot mode.

An example of the typical operation of the communications bridge and associated processors when in boot mode is now described.

An external host (not shown) writes initial boot loader code (hereinafter referred to as CappCopy) for the COMMS processor 314 into RAM 351 of the external host interface 350. RAM 351 is typically configured as contiguous RAM and is sometimes referred to as mailbox memory.

The communications processor 314 executes CappCopy from RAM 351 via communications link 352. CappCopy copies itself to RAM 315, conveniently to the top of RAM 315.

The external host writes main boot loader code (hereinafter CommsBoot) into RAM 351 of the external host interface 350. The COMMS processor 314 executes CappCopy from RAM 315. CappCopy copies CommsBoot from the external host interface RAM 351 to RAM 315, conveniently to the bottom of RAM 315.

The external host writes boot loader code for the pointer processor 312 (hereinafter VappCopy), and/or other sub-processor or sub-system, into RAM 351 of the external host interface 350. The COMMS processor 314 executes CommsBoot which copies VappCopy from external host RAM 351 into the RAMs 318 (provided by FIFOs 318 in boot mode), which are typically configured as contiguous RAMs.

The external host writes application program code for the pointer processor 312, or other sub-processor, sub-system or equivalent, to RAM 351. The pointer processor 312 (or other sub-processor, sub-system or equivalent) executes VappCopy from RAMs 318 which copies the application code from external host RAM 351 to RAM 313 via CommsBoot. The pointer processor 312 (or other sub-processor, sub-system or equivalent) may then execute the downloaded application code from RAM 313.

The external host writes application program code for the COMMS processor 314 to external host RAM 351. The COMMS processor 314 executes CappCopy from RAM 315.

CappCopy copies the application program code for the COMMS processor 314 from RAM 351 to RAM 315, conveniently the bottom of RAM 315. The COMMS processor 314 may then execute the downloaded application program code from RAM 315.

Hence, this aspect of the invention provides an efficient booting mechanism through re-use of event queue FIFOs 318 configured as RAM during boot mode.

Hence, there is no need for the pointer processor 312 to have direct access to a host processor external to the multi-processor system.

It will be understood that this aspect of the invention is not limited to communication between the COMMS processor 314 and the pointer processor 312. Similar arrangements may be provided between the COMMS processor 314, or equivalent processor, and any other processor, sub-processor or sub-system in the multi-processor system.

1. An event queue apparatus comprising: one or more storage devices arranged to implement a plurality of event queues; and an event queue status indicator, including a respective status component for each event queue, wherein the apparatus is arranged to cause the status components to indicate if the respective event queue contains at least one event.

2. An apparatus as claimed in claim 1, wherein, each event queue is implemented by a respective first-in first-out (FIFO) memory.

3. An apparatus as claimed in claim 1, wherein said event queue status indicator comprises a data register, each status component comprising one or more respective bits of the data register.

4. An apparatus as claimed in claim 2, wherein each FIFO memory is associated with a respective fill level monitor arranged to monitor the number of events in the respective event queue and to cause the respective status component to indicate when the respective event queue is not empty.

5. An apparatus as claimed in claim 4, arranged for queuing events to be transmitted between a first processor and one or more second processors, wherein each FIFO memory includes a plurality of event data storage locations and is arranged to receive event data from one or more of said second processors, which event data is stored in a respective event data storage location, each FIFO memory being further arranged to supply the least recently received event data to said main processor.

6. An apparatus as claimed in claim 5, wherein each FIFO memory is associated with a respective read/write pointer generator arranged to generate a write pointer for identifying into which event data location event data is written, and a read pointer for identifying from which event data location event data is supplied to the first processor, wherein, after event data is written to one event data storage location, the read/write pointer generator adjusts the write pointer to identify the next available event storage location, and wherein, in response to receipt of a read request from said main processor, the read/write pointer generator adjusts the read pointer to identify the event data storage location holding the least recently received event data.

7. An apparatus as claimed in claim 6, wherein the fill level monitor is arranged to compare the respective values of the write pointer and the read pointer in order to determine if at least one event data storage location of the respective FIFO memory contains event data.

8. An apparatus as claimed in claim 7, wherein the fill level monitor is arranged to determine that at least one event data storage location holds event data if the value of the read pointer does not match the value of the write pointer.

9. A system comprising a first processor, one or more second processors and an event queue apparatus arranged to queue events to be transmitted between said first processor said one or more second processors, the event queue apparatus comprising: one or more storage devices arranged to implement a plurality of event queues; and an event queue status indicator, including a respective status component for each event queue, wherein the apparatus is arranged to cause the status components to indicate if the respective event queue contains at least one event.

10. A system as claimed in claim 9, wherein said first processor is arranged to associate a respective priority with each status component and is further arranged to select to handle an event from the event queue associated with the highest priority of the or each event queue in respect of which the respective status component identifies as containing at least one event.

11. A system as claimed in claim 10, wherein said first processor associates a respective priority with each status component depending on the position of the status component in the event queue status indicator.

12. In a system as claimed in claim 10, a method of managing a plurality of event queues, the method comprising: associating a respective priority with each status component; and selecting to handle an event from the event queue associated with the highest priority of the or each event queue in respect of which the respective status component identifies as containing at least one event.

13. A computer program product comprising computer useable instructions for causing a computer to perform the method of claim 12.

14. A network element for a synchronous transport system, the network element comprising a system as claimed in claim 9.
